(19) United States
(12) Patent Application Publication
(10) Pub. No.: US 2007/0059452 A1
(43) Pub. Date: Mar. 15, 2007

(54) Formation of nanostructured layers through continued screw dislocation growth

(76) Inventors: Mark K. Debe, Stillwater, MN (US); Raymond J. Ziegler, Glenwood City, WI (US); Susan M. Hendricks, Cottage Grove, MN (US)

Correspondence Address: 3M INNOVATIVE PROPERTIES COMPANY, PO BOX 33427, ST. PAUL, MN, 55133-3427, US

(21) Appl. No.: 11/225,690

(22) Filed: Sep. 13, 2005

(51) Int. Cl. B05D 5/12; B05D 3/02; B05D 7/00

(52) U.S. Cl. 427/402; 427/372.2; 427/115

(57) ABSTRACT

Processes for extending the length of nanostructured support elements of thin film layers are described. The processes involve the initial formation nanostructured support elements during a first annealing step. A coating of material is deposited on the nanostructured support elements. During a second annealing step the initially formed nanostructured support elements longitudinally extend. Longer nanostructured support elements provide increased surface area for supporting catalyst material, thus allowing higher catalyst loading across the layer. Layers having extended nanostructured support elements are particularly useful for electrochemical devices such as fuel cells where catalyst activity is related to the surface area available to support the catalyst.

### FIELD OF THE INVENTION

The present invention relates generally to methods of making thin film nanostructured layers.

### BACKGROUND OF THE INVENTION

Electrochemical devices, such as proton exchange membrane fuel cells, sensors, electrolyzers, chlor-alkali separation membranes, and the like, have been constructed from membrane electrode assemblies (MEAs). An MEA used in a typical electrochemical cell, for example, includes an ion conductive membrane (ICM) that is in contact with an anode and a cathode. The anode/membrane/cathode structure is sandwiched between two porous, electrically conductive elements called diffusion current collectors (DCCs) to form a five layer MEA. Ions formed at the anode are transported to the cathode, allowing current to flow in an external circuit connecting the electrodes.

The ICM typically comprises a polymeric electrolyte material, which may constitute its own structural support or may be contained in a porous structural membrane. Cation- or proton-transporting polymeric electrolyte materials may be salts of polymers containing anionic groups and are often partially or completely fluorinated.

Fuel cell MEAs have been constructed using catalyst electrodes in the form of applied dispersions of either Pt or carbon supported Pt catalysts. A catalyst form used for polymer electrolyte membranes is Pt or Pt alloys coated onto larger carbon particles by wet chemical methods, such as reduction of chloroplatnic acid. This form of catalyst is dispersed with ionomeric binders, solvents, and often polytetrafluoroethylene (PTFE) particles to form an ink, paste, or dispersion that is applied either to the membrane or the diffusion current collector.

More recently, catalyst layers have been formed using nanostructured support elements bearing particles or thin films of catalytic material. The nanostructured catalyst electrodes may be incorporated into very thin surface layers of the ICM forming a dense distribution of catalyst particles. The use of nanostructured thin film (NSTF) catalyst layers allows higher catalyst utilization and more durable catalyst than catalyst layers formed by dispersion methods.

The present invention describes methods for making enhanced catalyst layers used for electrochemical devices and offers various advantages over the prior art.

### SUMMARY OF THE INVENTION

The present invention is directed to a methods for forming extended nanostructured support elements by continued growth of the support elements. The nanostructured support elements formed by the processes described herein are useful in a variety of chemical and electrochemical devices.

One embodiment of the invention involves a method for forming longitudinally extended nanostructured support elements. A first layer of material is deposited on a substrate. The layer is annealed to form a layer of nanostructured support elements. A second layer of the material is deposited on the nanostructured support elements. The second layer is annealed to longitudinally extend the nanostructured support elements.

For example, the material used to form the extended nanostructured support elements comprises an organic-based material such as perylene red. The first and second layers may be annealed in a vacuum at a temperature of about 160° C. to about 270° C. for about 2 minutes to about 6 hours. The tips of the nanostructured support elements comprise screw dislocations. Annealing the second layer of material continues the growth of the nanostructured support elements at the screw dislocations.

The extended nanostructured support elements may have an aspect ratio of length to mean cross sectional dimension diameter in a range of about 3:1 to about 200:1, a length greater than about 1.5 μm, and an a real density in a range from about 10⁷ to about 10¹¹ nanostructured support elements per cm².

According to one aspect of the invention, the extended nanostructured support elements may be formed on a microtextured substrate. According to another aspect of the invention, the substrate may be diffusion current collector. The extended nanostructured support elements may be coated with a catalyst material to form a nanostructured thin film catalyst layer. According to one implementation, the catalyst material comprises a metal, such as a platinum group metal. The catalyst coated extended nanostructured support elements may be transferred to at least one surface of an ion conductive membrane to form a catalyst coated membrane. Transfer of the catalyst coated nanostructured elements involves placing the catalyst coated nanostructured elements against a surface of the ion conductive membrane and applying pressure and optionally heat to bond the catalyst coated nanostructured elements to the membrane. According to one aspect of the invention, the extended nanostructured support elements may be used to form nanostructured thin film catalyst layers useful in membrane electrode assemblies and electrochemical devices such as fuel cells and electrolyzers.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a flowchart of a method of making a layer having extended nanostructured support elements in accordance with an embodiment of the invention;

FIG. 2 is a flowchart of a method of making a catalyst coated ion conductive membrane in accordance with embodiments of the invention;

FIG. 3 is a scanning electron micrograph of a cross section of a surface where the nanostructured layer conforms to a microtextured shape in accordance with embodiments of the invention;

FIG. 4A illustrates a fuel cell that utilizes one or more nanostructured catalyst layers formed in accordance with embodiments of the invention;

FIG. 4B illustrates an embodiment of a fuel cell assembly comprising an MEA having nanostructured catalyst layers formed in accordance with embodiments of the invention;

FIGS. 5-8 depict systems in which a fuel cell assembly as illustrated by the embodiments herein may be utilized;

FIGS. 9A and 9B are scanning electron microscope (SEM) images illustrating the increase in the length of nanostructured support elements produced in accordance with embodiments of the invention;

FIGS. 10A and 10B are SEM plan views from which the number of nanostructured support elements per unit area can be determined; and

FIGS. 11A and 11B are SEM images illustrating annealed and non-annealed layers, respectively.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

One important property of a surface or thin film is its surface area. The degree to which molecules adsorb onto, react with other molecules or with each other on the surface depends directly on the available surface area. In heterogeneous chemical or electrochemical catalysis the effectiveness of the processes occurring on the surface is determined by the amount of surface area. It is advantageous to be able to control and increase the area of a surface. Forming structured elements (microstructured and/or nanostructured elements) increases the surface area of a layer.

The present invention is directed to nanostructured layers and methods of making such layers. The layers described herein include nanostructured support elements having increased length over those previously achievable. Longer nanostructured support elements provide increased surface area for supporting catalyst particles, thus allowing higher mass specific area (m²/g) to be deposited across the layer. Layers having longitudinally extended nanostructured support elements as described herein are particularly useful for chemical and/or electrochemical devices such as fuel cells, batteries, electrolyzers, reformers, catalytic converters, oxidizers, and other devices where catalyst activity is related to the surface area available to support catalyst particles.

The nanostructured layers described in the embodiments herein can be used to form catalyst layers used in membrane electrode assemblies (MEAs). In these applications, the surface area of the catalyst layers is related to their performance in a fuel cell or other electrochemical device. The surface area of nanostructured thin film catalysts is determined by at least four principle characteristics occurring at different spatial scales. These characteristics include: the surface roughness of the catalyst coating on each individual nanostructured support element, the geometric surface area of an average nanostructured support element, which may be approximated as a right circular cylinder, the number of support elements per unit area, and the surface area of the substrate on which the nanostructured elements are grown.

To a first approximation, the geometric surface area of a single layer nanostructured film can be simply calculated by treating the individual nanostructured elements as right circular cylinders, having smooth surfaces, diameters W, lengths L, and number density N per square cm. Neglecting, for simplicity, the area of the nanostructured element tips, the surface area of the film per unit planar area is simply S=πW×L×N. If in addition the surfaces of the nanostructured elements are not smooth, but have a roughness factor R (>1) compared to a smooth surface, then S=πW×L×N×R. Finally, if the nanostructured elements are grown on a larger scale microtextured substrate having a surface area increase over the planar case of α, then S=απW×L×N×R. It can be seen from this expression for S that there are five parameters or ways to increase S. The nanostructured layers described herein include nanostructured elements having increased length (L), which increases the surface area (S) of the catalyst layer.

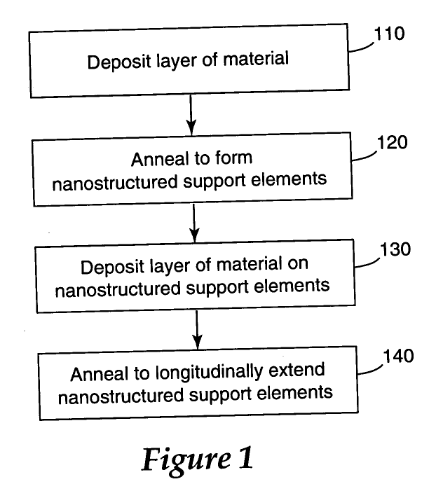

The formation of a nanostructured layer in accordance with embodiments of the present invention is illustrated in the flowchart of FIG. 1. The process involves deposition 110 of a first layer of material and formation 120 of nanostructured support elements during a first annealing step. A second layer of material is deposited 130 on the initially formed nanostructured support elements. During a second annealing step 140, the initially formed nanostructured support elements longitudinally extend. The methods described herein yield nanostructured layers with longer nanostructured support elements than those previously produced.

The nanostructured support elements can have a variety of orientations and straight and curved shapes, (e.g., whiskers, rods, cones, pyramids, spheres, cylinders, laths, tubes, and the like, that can be twisted, curved, hollow or straight). In some embodiments, the nanostructured support elements are formed using an organic pigment. For example, the organic pigment may comprise a material having delocalized π-electrons. In some implementations, the nanostructured support elements are formed of C.I. PIGMENT RED 149 (perylene red). The materials used to form the support elements preferably are capable of forming a continuous layer when deposited onto a substrate. In some applications, the thickness of the continuous layer is in the range from about 1 nanometer to about one thousand nanometers.

Methods for forming the initial nanostructured support elements are described in commonly owned U.S. Pat. Nos. 4,812,352, 5,879,827, and 6,136,412 which are incorporated herein by reference. Methods for making organic nanostructured layers are disclosed in Materials Science and Engineering, A158 (1992), pp. 1-6; J. Vac. Sci. Technol. A, 5 (4), July/August, 1987, pp.1914-16; J. Vac. Sci. Technol. A, 6, (3), May/August, 1988, pp. 1907-11; Thin Solid Films, 186, 1990, pp. 327-47; J. Mat. Sci., 25, 1990, pp. 5257-68; Rapidly Quenched Metals, Proc. of the Fifth Int. Conf. on Rapidly Quenched Metals, Wurzburg, Germany (Sep. 3-7, 1984), S. Steeb et al., eds., Elsevier Science Publishers B.V., New York, (1985), pp.1117-24; Photo. Sci. and Eng., 24, (4), July/August, 1980, pp. 211-16; and U.S. Pat. Nos. 4,568,598, 4,340,276, the disclosures of the patents are incorporated herein by reference. Properties of catalyst layers using carbon nanotube arrays are disclosed in “High Dispersion and Electrocatalytic Properties of Platinum on Well-Aligned Carbon Nanotube Arrays,” Carbon 42 (2004) 191-197.

The initial deposition of material may involve coating a layer of organic pigment onto a substrate using techniques known in the art for applying a layer of an organic material onto a substrate, including, for example, vapor phase deposition (e.g., vacuum evaporation, sublimation, and chemical vapor deposition), and solution coating or dispersion coating (e.g., dip coating, spray coating, spin coating, blade or knife coating, bar coating, roll coating, and pour coating (i.e., pouring a liquid onto a surface and allowing the liquid to flow over the surface).

In one embodiment, an initial organic layer of perylene red, or other suitable material, is applied by physical vacuum vapor deposition (i.e., sublimation of the organic material under an applied vacuum). The thickness of the initially deposited perylene red layer may be in the range from about 0.03 to about 0.5 μm, for example. The initial organic layer is annealed in a vacuum (i.e., less than about 0.1 Pascal) during a first annealing step to grow the nanostructured support elements from the as-deposited perylene red. The coated perylene red may be annealed, for example, at a temperature in the range from about 160 to about 270° C. The annealing time necessary to convert the original organic layer to the nanostructured layer is dependent on the annealing temperature.

Typically, an annealing time in the range from about 2 minutes to about 6 hours is sufficient. For example, the annealing may be in the range from about 20 minutes to about 4 hours. For perylene red, the optimum annealing temperature to convert substantially all of the original organic layer nanostructured support elements, but not sublime away the originally deposited material, is observed to vary with the deposited layer thickness. Typically, for original organic layer thicknesses of about 0.05 to about 0.15 μm, the annealing temperature is in the range of about 245 to about 270° C.

The basic mechanism for growth of the initial nanostructured support elements results from emergent screw dislocations in the as-deposited layer of organic pigment that serve as growth sites for the oriented, discrete, crystalline whiskers. As the film is heated (annealed) in vacuum, the perylene molecules diffuse over the surface to the dislocation sites, rather than re-subliming, and begin the growth of the nanostructured support elements.

Previously, the only known method to achieve longer nanostructured support elements having a given areal number density was to begin with a thicker layer perylene red (or other material) since the volume of perylene red is conserved, up to a limit. It was previously believed that there was a limit to the length of the nanostructured support elements. The limit was believed to be directly related to the temperature of annealing because the maximum length of the whiskers was determined by the temperature at which the elements resublime from the surface. By this rationale, growing longer nanostructured support elements would require heating them to a higher temperature, but at some point the perylene molecules begin to sublime instead of adding to the screw dislocations at the growth tips of the nanostructured support elements.

Embodiments of the invention described herein involve a novel process for obtaining longer nanostructured support elements of perylene red, or other organic pigment materials than was achievable by previous methods. Longer nanostructured support elements provide increased surface area for the nanostructured layer which is beneficial in various applications. For example, when the nanostructured support elements are used to support catalyst coatings, increasing the surface area of the nanostructured layer increases the overall catalytic activity.

After initial formation of the nanostructured support elements by the methods described above, a second layer of material is deposited over the nanostructured support elements. For example, a second layer of perylene red, or other material, may be vacuum coated onto existing nanostructured support elements at or near room temperature. A second annealing step follows the second deposition of material. The second deposition and annealing steps continue the longitudinal growth of the nanostructured support elements. In one implementation, the second layer may comprise a conformal coating of perylene red having a thickness of about 500 Angstroms. The assembly is then annealed a second time at a temperature in a range of about 160 to about 270° C. for about 2 minutes to about 6 hours.

Nanostructured support elements formed during the initial anneal are extended in the second annealing step. A mechanism for the continued growth of the nanostructured support elements from the second layer involves re-distribution of the new perylene material to the screw dislocations on the original nanostructured support element tips. The continued growth of the nanostructured support elements may occur even if the initial nanostructured support elements are exposed to air or stored in air for long periods of time. The second layer of material is observed to conformally coat the initial elements and the second annealing step causes the new perylene to diffuse to the screw dislocations at the growth tips of the initial nanostructured support elements to longitudinally increase the elements.

The shape and orientation of the longitudinally extended elements generally conform to the shape and orientation of the initially formed elements. Orientation of the nanostructured support elements can be affected by the substrate temperature, the deposition rate, and angle of incidence during deposition of the material layers. In one embodiment, nanostructured support elements made of perylene red have a vertical dimension greater than about 1.5 μm, a horizontal dimension that ranges from about 0.03 μm to about 0.06 μm, and an areal number density in a range from about 10⁷ to about 10¹¹ nanostructured support elements per cm². The longitudinally extended nanostructured support elements may have an aspect ratio of length to diameter of about 3:1 to about 200:1. For example, the longitudinally extended nanostructured support elements may have an aspect ratio of about 40:1.

Useful organic materials for forming the nanostructured layer include, for example, planar molecules comprising chains or rings over which π-electron density is extensively delocalized. These organic materials generally crystallize in a herringbone configuration. For example, in some embodiments, organic materials broadly classified as polynuclear aromatic hydrocarbons and heterocyclic aromatic compounds are used. These materials include, for example, naphthalenes, phenanthrenes, perylenes, anthracenes, coronenes, and pyrenes. As previously discussed, a useful polynuclear aromatic hydrocarbon is N,N′-di(3,5-xylyl)perylene-3,4,9, 10 bis(dicarboximide) (commercially available under the trade designation “C. I. PIGMENT RED 149” from American Hoechst Corp. of Somerset, N.J.), herein designated “perylene red.”

Inorganic materials that may be used to produce nanostructured layers include, for example, carbon, diamond-like carbon, carbon nanotubes, ceramics (e.g., metal or non-metal oxides such as alumina, silica, iron oxide, and copper oxide; metal or non-metal nitrides such as silicon nitride and titanium nitride; and metal or non-metal carbides such as silicon carbide; metal or non-metal borides such as titanium boride); metal or non-metal sulfides such as cadmium sulfide and zinc sulfide; metal silicides such as magnesium silicide, calcium silicide, and iron silicide; metals (e.g., noble metals such as gold, silver, platinum, osmium, iridium, palladium, ruthenium, rhodium, and combinations thereof; transition metals such as scandium, vanadium, chromium, manganese, cobalt, nickel, copper, zirconium, and combinations thereof, low melting metals such as bismuth, lead, indium, antimony, tin, zinc, and aluminum; refractory metals such as tungsten, rhenium, tantalum, molybdenum, and combinations thereof); and semiconductor materials (e.g., diamond, germanium, selenium, arsenic, silicon, tellurium, gallium arsenide, gallium antimonide, gallium phosphide, aluminum antimonide, indium antimonide, indium tin oxide, zinc antimonide, indium phosphide, aluminum gallium arsenide, zinc telluride, and combinations thereof).

As previously discussed, the nanostructured layers in accordance with the embodiments described herein may be used to form nanostructured catalyst layers suitable for use in fuel cell membrane electrode assemblies (MEAs). The longer nanostructured support elements advantageously provide higher catalyst loading profiles for MEAs, such as those used in proton exchange membrane (PEM) fuel cells and/or electrolyzers.

One or more layers of catalyst material conformally coating the extended nanostructured support elements serves as a functional layer imparting desirable catalytic properties, and may also impart electrical conductivity and mechanical properties (e.g., strengthens and/or protects the elements comprising the nanostructured layer), and low vapor pressure properties.

The conformal coating material can be an inorganic material or it can be an organic material including a polymeric material. Useful inorganic conformal coating materials include platinum group metals, including Pt, Pd, Au, Ru, etc., or alloys of these materials and also those inorganic materials described above that may be used for forming the nanostructured support elements. Useful organic materials include Fe/C/N, conductive polymers (e.g., polyacetylene), and polymers derived from poly-p-xylylene, for example.

The preferred thickness of the conformal coating is typically in the range from about 0.2 to about 50 nm. The conformal coating may be deposited onto the nanostructured support elements using conventional techniques, including, for example, those disclosed in U.S. Pat. Nos. 4,812,352 and 5,039,561, the disclosures of which are incorporated herein by reference. Any method that avoids disturbance of the nanostructured support element layer by mechanical forces can be used to deposit the conformal coating. Suitable methods include, for example, vapor phase deposition (e.g., vacuum evaporation, sputter coating, and chemical vapor deposition) solution coating or dispersion coating (e.g., dip coating, spray coating, spin coating, pour coating (i.e., pouring a liquid over a surface and allowing the liquid to flow over the nanostructured layer, followed by solvent removal)), immersion coating (i.e., immersing the nanostructured layer in a solution for a time sufficient to allow the layer to adsorb molecules from the solution, or colloidals or other particles from a dispersion), electroplating and electroless plating. The conformal coating may be deposited by vapor phase deposition methods, such as, for example, ion sputter deposition, cathodic arc deposition, vapor condensation, vacuum sublimation, physical vapor transport, chemical vapor transport, metalorganic chemical vapor deposition, ion assisted deposition or JET VAPOR DEPOSITION ®, for example. In some embodiments, the conformal coating material is a catalytic metal or metal alloy.

For the deposition of a patterned conformal coating, the deposition techniques are modified by means known in the art to produce such discontinuous coatings. Known modifications include, for example, use of masks, shutters, moving substrate, directed ion beams, and deposition source beams.

In some applications, key aspects of the formed acicular nanostructured support elements is that they be easily transferable from the initial substrate into the membrane to form the MEA catalyst electrode layer; they allow a higher weight percent loading of catalyst coating on the nanostructured support elements to be deposited on the surface, preferably at least an 80 wt % ratio of catalyst coating to the combined weight of support and catalyst particles; they have sufficient number density and aspect ratio to provide a high value of surface area support for the catalyst, at least 10 to 15 times the planar area of the substrate; and the shape and orientation of the acicular nanostructured support elements on the initial substrate are conducive to uniform coating with catalyst material.

Some catalyst deposition methods result in the formation of thin catalyst films comprising polycrystalline catalyst particles with sizes in the several tens of nanometers range, preferably in a range from about 2 nm to about 50 nm, which uniformly coat at least a portion of the outer surface area of the support particles.

In general, the catalyst is deposited on the nanostructured support elements at nucleation sites which grow into catalyst particles. It has been discovered that the size of the resultant catalyst particle is a function of the initial size of the support element and the amount of catalyst loading. For the same catalyst loading, in mg/cm², longer catalyst supports will result in thinner catalyst films with smaller catalyst particle sizes, compared to shorter catalyst supports of the same cross-sectional dimensions.

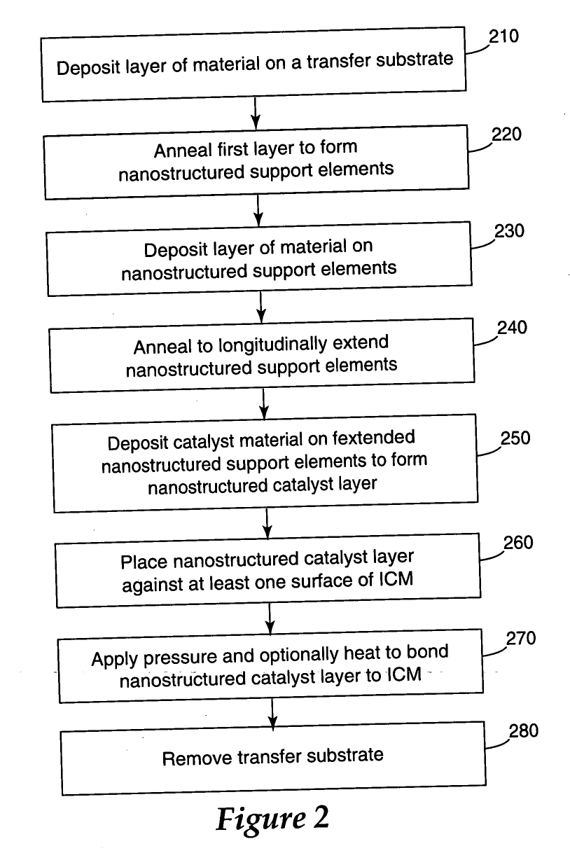

The flowchart of FIG. 2 illustrates a method of making a catalyst coated membrane in accordance with embodiments of the invention. A first layer of material is deposited 210 on a transfer substrate and annealed 220 to form a layer of nanostructured support elements. A second film is deposited 230 on the nanostructured support elements and is annealed 240 to longitudinally extend the nanostructured support elements.

A catalyst material is deposited 250 on the extended nanostructured support elements to form a thin film nanostructured catalyst layer. The nanostructured catalyst layer is then placed against 260 one or both surfaces of an ion conductive membrane (ICM) to form an intermediate assembly. Pressure, and optionally heat, are applied 270 to the intermediate assembly to bond the catalyst layer to the ICM. The transfer substrate is removed 280 in a delamination step leaving a catalyst coated membrane.

Materials useful as a substrate for deposition of the nanostructured layers include those which maintain their integrity at the temperature and vacuum imposed upon them during the vapor deposition and annealing steps. The substrate can be flexible or rigid, planar or non-planar, convex, concave, textured, or combinations thereof. The substrate may be made of a porous material, for example, which is useful in filter applications.

Preferred substrate materials include organic materials and inorganic materials (including, for example, glasses, ceramics, metals, and semiconductors). Preferred inorganic substrate materials are glass or metal. A preferred organic substrate material is a polyimide. More preferably, the substrate, if non-metallic, is metallized with a 10-70 nm thick layer of an electrically conductive metal for removal of static charge. The layer may be discontinuous.

Representative organic substrates include those that are stable at the annealing temperature, for example, polymers such as polyimide film (commercially available, for example, under the trade designation KAPTON ® from DuPont Electronics, Wilmington, Del.), high temperature stable polyimides, polyesters, polyamids, and polyaramids.

Metals useful as substrates include, for example, aluminum, cobalt, chrome, molybdenum, nickel, platinum, tantalum, or combinations thereof. Ceramics useful as a substrate material include, for example, metal or non-metal oxides such as alumina and silica. A useful inorganic nonmetal is silicon.

The ion conductive membrane (ICM) may be composed of any suitable ion exchange electrolyte. The electrolytes are preferably solids or gels. Electrolytes useful in the present invention can include ionic conductive materials, such as polymer electrolytes, and ion-exchange resins. The electrolytes are preferably proton conducting ionomers suitable for use in proton exchange membrane fuel cells.

Copolymers of tetrafluoroethylene (TFE) and a co-monomer according to the formula: FSO₂—CF₂—CF₂—O—CF(CF₃)—CF₂—O—CF═CF₂ are known and sold in sulfonic acid form, i.e., with the FSO₂— end group hydrolyzed to HSO₃—, under the trade name NAFION ® by DuPont Chemical Company, Wilmington, Del. NAFION ® is commonly used in making polymer electrolyte membranes for use in fuel cells. Copolymers of tetrafluoroethylene (TFE) and a co-monomer according to the formula: FSO₂—CF₂—CF₂—O—CF═CF₂ are also known and used in sulfonic acid form, i.e., with the FSO₂— end group hydrolyzed to HSO₃—, in making polymer electrolyte membranes for use in fuel cells. Most-preferred are copolymers of tetrafluoroethylene (TFE) and FSO₂—CF₂CF₂CF₂CF₂—O—CF═CF₂, with the FSO₂— end group hydrolyzed to HSO₃—.

Ionic conductive materials useful in the invention can be complexes of an alkalai metal or alkalai earth metal salt or a protonic acid with one or more polar polymers such as a polyether, polyester, or polyimide, or complexes of an alkalai metal or alkalai earth metal salt or a protonic acid with a network or crosslinked polymer containing the above polar polymer as a segment. Useful polyethers include: polyoxyalkylenes, such as polyethylene glycol, polyethylene glycol monoether, polyethylene glycol diether, polypropylene glycol, polypropylene glycol monoether, and polypropylene glycol diether; copolymers of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; esters, such as phosphoric acid esters, aliphatic carboxylic acid esters or aromatic carboxylic acid esters of the above polyoxyalkylenes. Copolymers of, e.g., polyethylene glycol with dialky siloxanes, polyethylene glycol with maleic anhydride, or polyethylene glycol monoethyl ether with methacrylic acid are known in the art to exhibit sufficient ionic conductivity to be useful in an ICM of the invention.

Useful complex-forming reagents can include alkalai metal salts, alkalai metal earth salts, and protonic acids and protonic acid salts. Counterions useful in the above salts can be halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, tetrafluoroethylene sulfonic acid, hexafluorobutane sulfonic acid, and the like.

Ion-exchange resins useful as electrolytes in the present invention include hydrocarbon- and fluorocarbon-type resins. Hydrocarbon-type ion-exchange resins can include phenolic or sulfonic acid-type resins; condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins can include hydrates of a tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases, and can be preferable for composite electrolyte membranes useful in the invention. One family of fluorocarbon-type resins having sulfonic acid group functionality is the NAFION ® resins (DuPont Chemicals, Wilmington, Del., available from ElectroChem, Inc., Woburn, Mass., and Aldrich Chemical Co., Inc., Milwaukee, Wis.). Other fluorocarbon-type ion-exchange resins that can be useful in the invention comprise (co)polymers of olefins containing aryl perfluoroalkyl sulfonylimide cation-exchange groups, having the general formula (I): CH.sub.2═CH—Ar—SO₂ —N—SO₂ (C₁+n F_{3 +2}n), wherein n is 0-11, preferably 0-3, and most preferably 0, and wherein Ar is any substituted or unsubstituted divalent aryl group, preferably monocyclic and most preferably a divalent phenyl group, referred to as phenyl herein. Ar may include any substituted or unsubstituted aromatic moieties, including benzene, naphthalene, anthracene, phenanthrene, indene, fluorene, cyclopetadiene and pyrene, wherein the moieties are preferably molecular weight 400 or less and more preferably 100 or less. Ar may be substituted with any group as defined herein. One such resin is p-STSI, an ion conductive material derived from free radical polymerization of styrenyl trifluoromethyl sulfonylimide (STSI) having the formula (II): styrenyl-SO₂ N⁻—SO₂ CF₃.

ICM's may also be composite membranes, comprising a porous membrane material combined with any of the above-described electrolytes. Any suitable porous membrane may be used. Porous membranes useful as reinforcing membranes of the invention can be of any construction having sufficient porosity to allow at least one liquid solution of an electrolyte to be infused or imbibed thereinto and having sufficient strength to withstand operating conditions in an electrochemical cell. Preferably, porous membranes useful in the invention comprise a polymer that is inert to conditions in the cell, such as a polyolefin, or a halogenated, preferably fluorinated, poly(vinyl) resin. Expanded PTFE membranes may be used, such as Poreflon™, produced by Sumitomo Electric Industries, Inc., Tokyo, Japan, and Tetratexm™ produced by Tetratec, Inc., Feasterville, Pa.

Porous membranes useful in the present invention may comprise microporous films prepared by thermally-induced phase separation (TIPS) methods, as described in, e.g., U.S. Pat. Nos. 4,539,256, 4,726,989, 4,867,881, 5,120,594 and 5,260,360, the teachings of which are incorporated herein by reference. TIPS films exhibit a multiplicity of spaced, randomly dispersed, equiaxed, nonuniform shaped particles of a thermoplastic polymer, optionally coated with a liquid that is immiscible with the polymer at the crystallization temperature of the polymer, preferably in the form of a film, membrane, or sheet material. Micropores defined by the particles preferably are of sufficient size to allow electrolyte to be incorporated therein.

Polymers suitable for preparing films by the TIPS process include thermoplastic polymers, thermosensitive polymers, and mixtures of these polymers, so long as the mixed polymers are compatible. Thermosensitive polymers such as ultrahigh molecular weight polyethylene (UHMWPE) cannot be melt-processed directly but can be melt-processed in the presence of a diluent that lowers the viscosity thereof sufficiently for melt processing.

Suitable polymers include, for example, crystallizable vinyl polymers, condensation polymers, and oxidation polymers. Representative crystallizable vinyl polymers include, for example, high- and low-density polyethylene, polypropylene, polybutadiene, polyacrylates such as poly(methyl methacrylate), fluorine-containing polymers such as poly(vinylidene fluoride), and the like. Useful condensation polymers include, for example, polyesters, such as poly(ethylene terephthalate) and poly(butylene terephthalate), polyamides, including many members of the Nylon™ family, polycarbonates, and polysulfones. Useful oxidation polymers include, for example, poly(phenylene oxide) and poly(ether ketone). Blends of polymers and copolymers may also be useful in the invention. Preferred polymers for use as reinforcing membranes of the invention include crystallizable polymers, such as polyolefins and fluorine-containing polymers, because of their resistance to hydrolysis and oxidation. Preferred polyolefins include high density polyethylene, polypropylene, ethylene-propylene copolymers, and poly(vinylidene fluoride).

Where used, the diffusion current collector (DCC) can be any material capable of collecting electrical current from the electrode while allowing reactant gasses to pass through. The DCCs provide porous access of gaseous reactants and water vapor to the catalyst and membrane, and also collect the electronic current generated in the catalyst layer for powering the external load.

Diffusion current collectors (DCCs) include a microporous layer (MPL) and an electrode backing layer (EBL), where the MPL. is disposed between the catalyst layer and the EBL. The carbon fiber constructions of EBL's generally have coarse and porous surfaces, which exhibit low bonding adhesion with catalyst layers. To increase the bonding adhesion, the microporous layer is coated to the surface of EBL's. This smoothens the coarse and porous surfaces of EBL's, which provides good bonding adhesion with catalyst layers.

EBL's may be any suitable electrically conductive porous substrate, such as carbon fiber constructions (e.g., woven and non-woven carbon fiber constructions). Examples of commercially available carbon fiber constructions include trade designated “AvCarb P50” carbon fiber paper from Ballard Material Products, Lowell, MA; “Toray” carbon paper which may be obtained from ElectroChem, Inc., Woburn, MA; “SpectraCarb” carbon paper from Spectracorp, Lawrence, MA; “AFN” non-woven carbon cloth from Hollingsworth & Vose Company, East Walpole, MA; and “Zoltek” carbon cloth from Zoltek Companies, Inc., St. Louis, Mo. EBL's may also be treated to increase or impart hydrophobic properties. For example, EBL's may be treated with highly-fluorinated polymers, such as polytetrafluoroethylene (PTFE) and fluorinated ethylene propylene (FEP).

Catalyst coated nanostructured support elements, as described herein, may be applied directly to the surface of the ICM but need not be embedded in their entirety. The catalyst coated nanostructured elements may be embedded only so far as necessary to create a firm attachment between the particles and the ICM. While as much as 99% of the volume of the catalyst coated nanostructured elements may be embedded within the ICM, preferably, no more than 95% of the volume of the catalyst coated nanostructured elements is contained within the ICM, and more preferably no more than 90%. In some embodiments, each nanostructured element may lie partially within and partially outside the ICM. In other embodiments, a part of the entire population of nanostructured elements may lie within the ICM and a part without, with some particles embedded, others non-embedded, and others partially embedded.

The nanostructured elements can be partially embedded in the surface of the ICM in a single orientation or in random directions. In the former case the catalyst coated nanostructured elements can be oriented parallel to the surface of the ICM so that in principle only catalyst on one side of the support particles contacts the solid polymer electrolyte, or they can be oriented more or less perpendicular to the ICM surface and have a fraction of their length embedded in the ICM surface, or the catalyst coated acicular-shaped support particles can have any intermediate position or combination of positions. Furthermore, the nanostructured elements may be broken or crushed so as to both further reduce their size and allow further compaction of the electrode layer. Preferably ionomer coats the acicular support elements for good proton conduction but voids remain between the catalyst coated acicular support elements for good reactant access to the catalyst surface.

Processes suitable for applying the catalyst coated nanostructured elements to the ICM to form the MEA include static pressing with heat and pressure, or for continuous roll production, laminating, nip rolling, or calendering, followed by delamination of the initial catalyst support film substrate from the ICM surface, leaving the catalyst particles embedded.

Nanostructured support elements formed on a substrate can be transferred and attached to the ICM by applying mechanical pressure and optionally heat and subsequently removing the original substrate. Any suitable source of pressure may be employed. A hydraulic press may be employed. Preferably, pressure may be applied by one or a series of nip rollers. This process is also adaptable to a continuous process, using either a flat bed press in a repeating operation or rollers in a continuing operation. Shims, spacers, and other mechanical devices intermediate between the source of pressure and the particle substrate may be employed for uniform distribution of pressure. The catalyst particles are preferably supported on a substrate which is applied to the ICM surface, such that the particles contact the membrane surface. In one embodiment, an ICM may be placed between two sheets of polyimide-supported layers of catalyst coated nanostructured elements which are placed against the ICM. Additional layers of uncoated polyimide and PTFE sheets are further layered on either side of the sandwich for uniform distribution of pressure, and finally a pair of stainless steel shims is placed outside of this assembly. The substrate is removed after pressing, leaving the catalyst coated nanostructured elements attached to the ICM. The pressure, temperature and duration of pressing may be any combination sufficient to partially embed the nanostructured elements in the membrane. The precise conditions used depend in part on the nature of the nanostructured elements used.

A pressure of between about 90 and about 900 MPa may be used to transfer the nanostructured layer to the ICM. In one embodiment, a pressure of between about 180 and about 270 MPa is used. The press temperature may be selected to be sufficient for attaching the catalyst coated nanostructured elements to the ICM, but below the glass transition temperature (T_{G}) of the membrane polymer. For example, the press temperature may be between about 80° C. and about 300° C., and most preferably between about 100° C. and about 150° C. The pressing time may be greater than about 1 second and may be about one minute. After loading into the press, the MEA components may be allowed to equilibrate to the press temperature, at low or no pressure, prior to pressing. Alternately, the MEA components may be preheated in an oven or other apparatus adapted for the purpose. Preferably the MEA components are preheated for 1-10 minutes before pressing. The MEA may be cooled before or after removal from the press. The platens of the press may be water cooled or cooled by any other suitable means. The MEA may be cooled for 1-10 minutes while still under pressure in the press. The MEA is preferably cooled to under about 50° C. before removal from the press. A press employing vacuum platens may optionally be used.

For example, an MEA may be made using a lamination procedure consisting of transfer of the catalyst-coated nanostructure elements onto the membrane by assembling a sandwich consisting of a high gloss paper, a 2 mil (50 μm) polyimide sheet, anode catalyst, membrane, cathode catalyst, 2 mil (50 μm) polyimide and a final sheet of high gloss paper. This assembly is fed through a hot two roll laminator at 132° C. (270° F.) at a roll speed of 1 foot/minute and adequate nip pressure to result in transfer of the catalyst to the membrane. The glossy paper and polyimide are then peeled away to leave the 3 layer catalyst coated membrane (CCM).

In another embodiment, the MEA can be formed at room temperature and pressures of between about 9 and about 900 MPa by pretreatment of the ICM with the appropriate solvent. This allows the water uptake ability of the ICM to remain high, and hence improves its conductivity. In contrast, the prior art requires elevated temperatures to obtain an intimate bond between the catalyst/ionomer layer and the ICM. By briefly exposing a perfluorosulfonic acid polymer membrane surface to a solvent, preferably heptane, that catalyst coated nanostructured support particles can be transferred to and partially embedded in the ICM from the support substrate, at room temperature.

In this embodiment, a pressure of between 9 and 900 MPa is preferably used. Most preferably, a pressure of between 45 and 180 MPa is used. Preferably the press temperature is room temperature, i.e. about 25° C., but may be anywhere between 0° and 50° C. The pressing time is preferably greater than 1 second and most preferably between 10 seconds and about one minute. Since the pressing occurs at room temperature, no preheating or post-press cool are required.

The ICM is pretreated by brief exposure to the solvent by any means, including immersion, contact with a saturated material, spraying, or condensation of vapor, but preferably by immersion. Excess solvent may be shaken off after the pretreatment. Any duration of exposure which does not compromise the ICM may be used, however, a duration of at least one second is preferred. The solvent used may be chosen from apolar solvents, heptane, isopropanol, methanol, acetone, IPA, C₈F₁₇SO₃H, octane, ethanol, THF, MEK, DMSO, cyclohexane, or cyclohexanone. Apolar solvents are preferred. Heptane is most preferred, as it is observed to have the optimum wetting and drying conditions and to allow complete transfer of the nanostructured catalysts to the ICM surface without causing the ICM to swell or distort.

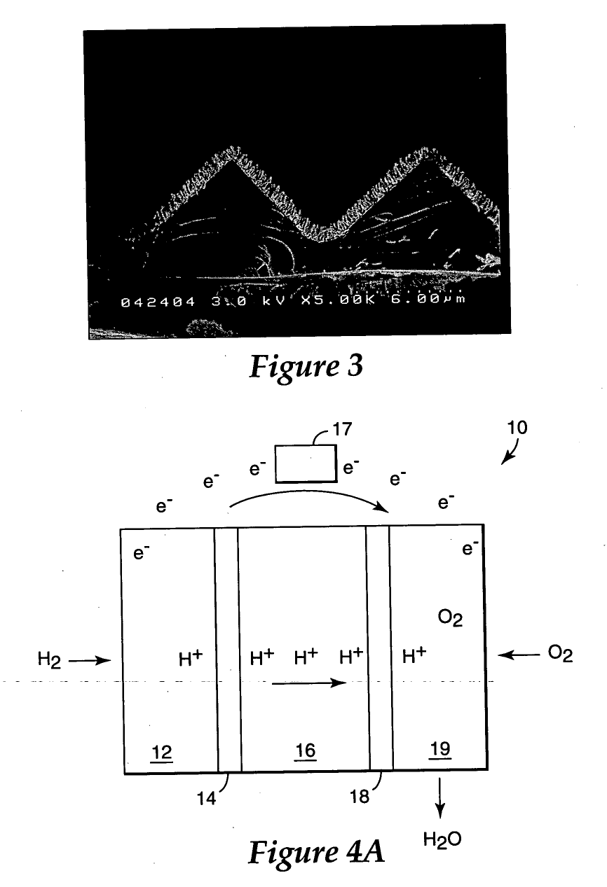

In addition to the nanostructured elements supporting the catalyst, the layers may also be imparted with microtextures having features sized in the 1-50 microns range, i.e., smaller than the membrane thickness but larger than the acicular catalyst support elements, so that the catalyzed membrane surface is also replicated with these microtextures. FIG. 3 is scanning electron micrograph of a cross section of such a catalyst coated membrane (CCM) surface where the nanostructured layer conforms to a microtextured shape. The actual nanostructured catalyst layer surface area per unit planar area of CCM (measured normal to the stacking axis of the CCM) is increased by the geometric surface area factor of the microtextured substrate. In the example illustrated in FIG. 3, this factor is 1.414, or the square root of two, since each part of the surface is at a 45° angle to the normal stacking axis. The depth of the microtextures can be made relatively small compared to the thickness of the ICM.

The microtextures can be imparted by any effective method. One preferred method is to form the nanostructured support elements on an initial substrate that is microtextured, denoted herein as a microtextured catalyst transfer substrate (MCTS). The microtextures are imparted to the CCM during the step of transferring the nanostructured elements to the ICM, and remain after the initial substrate is stripped away. The conditions of nanostructure and CCM formation are the same as described above. Another method is to impress or mold the microtexture into a formed CCM. It is not necessary that the microtextures be uniformly geometric. Randomly sized and arrayed features can serve the same purpose.

The increase in actual catalyst area per unit CCM planar area by microtexturing the catalyst electrode area can be achieved when the catalyst layer is sufficiently thin, about an order of magnitude thinner than the size of the microtexture features, and those microtexture features are smaller than the thickness of the ICM. For example, the thickness of the catalyzed surface region of the ICM in this invention can be 2 microns or less. The width of the microtextured features may be about 12 microns and the peak to valley height of the microtextured features may be about 6 microns, and the thickness of the ICM membrane can be 25 microns or larger.

When the microtextures are imparted by use of a microtextured substrate for the nanostructured support elements of this invention, two further advantages appear in the process for applying the catalyst and forming the MEA. A key aspect for membrane transfer applications, such as for fuel cells and electrolyzers, is that the nanostructured elements are initially disposed on a substrate from which they can be transferred to the membrane surface. The support particles may be more easily brushed off a flat substrate or damaged by winding up such a flat substrate around a core, such as would be done in a continuous web coating process. Having the nanostructured catalyst support elements on a microtextured substrate can prevent the possibility of damage because the vast majority of the much smaller catalyst coated support particles will reside in the valleys, below the peaks which will protect them from damage on roll-up.

A second process advantage provided by the microtextured substrate may be realized in the process of transferring the catalyzed support particles into the ICM surface. Often heat and pressure may be used, and removing air from the interface at the start of the pressing process can be important, such as by applying a vacuum. When transferring from large pieces of planar substrate carrying the nanostructured catalyst support elements, air can be trapped between the ICM and the support substrate. Having the microtextured peaks to space the ICM and substrate apart during evacuation can allow this air to be more effectively removed in the moments just before the press-transfer commences.

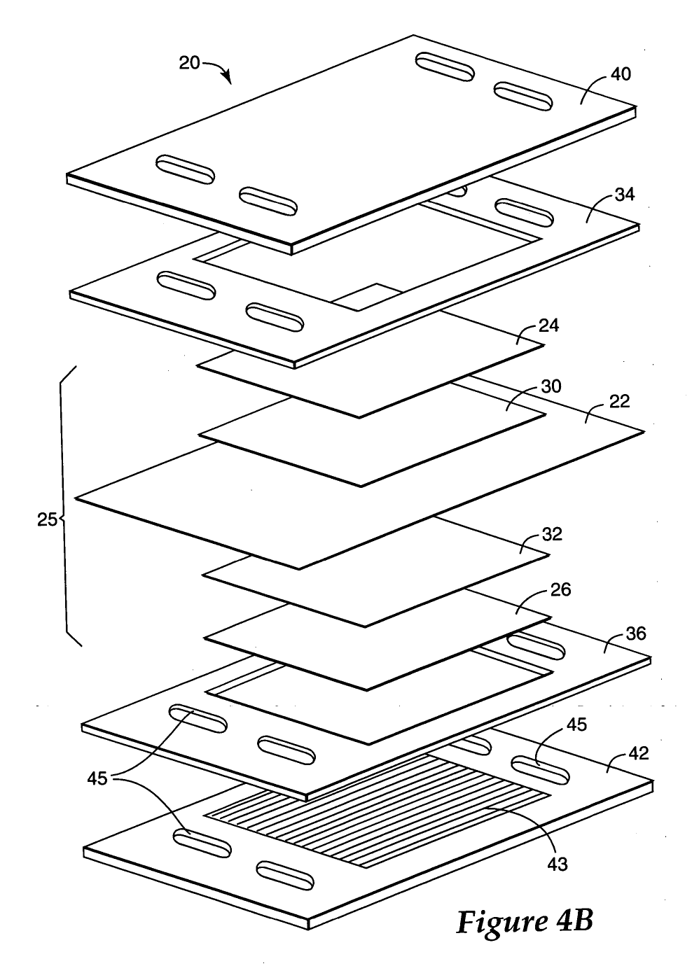

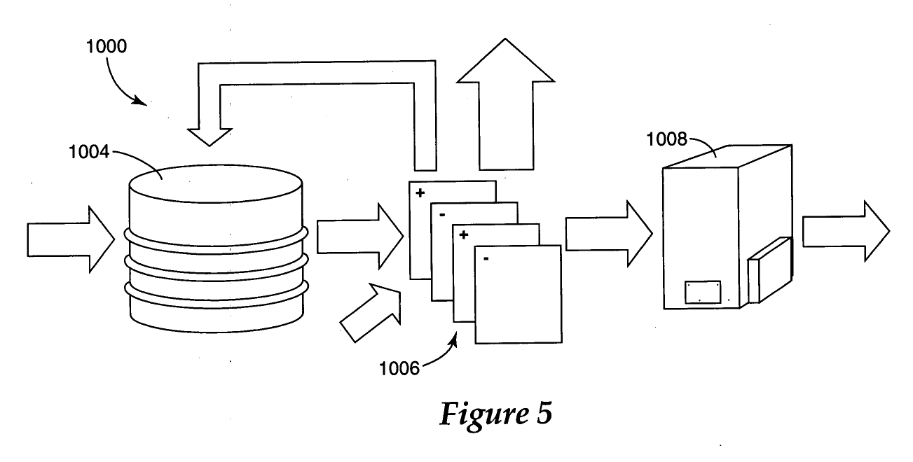

MEAs formed using the catalyst layers of the present invention may be incorporated in fuel cell assemblies and stacks of varying types, configurations, and technologies. A typical fuel cell is depicted in FIG. 4A. A fuel cell is an electrochemical device that combines hydrogen fuel and oxygen from the air to produce electricity, heat, and water. Fuel cells do not utilize combustion, and as such, fuel cells produce little if any hazardous effluents. Fuel cells convert hydrogen fuel and oxygen directly into electricity, and can be operated at much higher efficiencies than internal combustion electric generators, for example.

The fuel cell 10 shown in FIG. 4A includes a diffusion current collector (DCC) 12 adjacent an anode 14. Adjacent the anode 14 is an ion conductive membrane (ICM) 16. A cathode 18 is situated adjacent the ICM 16, and a second DCC 19 is situated adjacent the cathode 18. In operation, hydrogen fuel is introduced into the anode portion of the fuel cell 10, passing through the first DCC 12 and over the anode 14. At the anode 14, the hydrogen fuel is separated into hydrogen ions (H⁺) and electrons (e⁻).

The ICM 16 permits only the hydrogen ions or protons to pass through the ICM 16 to the cathode portion of the fuel cell 10. The electrons cannot pass through the ICM 16 and, instead, flow through an external electrical circuit in the form of electric current. This current can power an electric load 17, such as an electric motor, or be directed to an energy storage device, such as a rechargeable battery.

Oxygen flows into the cathode side of the fuel cell 10 via the second DCC 19. As the oxygen passes over the cathode 18, oxygen, protons, and electrons combine to produce water and heat.

Individual fuel cells, such as that shown in FIG. 4A, can be packaged as unitized fuel cell assemblies as described below. The unitized fuel cell assemblies, referred to herein as unitized cell assemblies (UCAs) or multi-cell assemblies (MCAs) can be combined with a number of other UCAs/MCAs to form a fuel cell stack. The UCAs/MCAs may be electrically connected in series with the number of UCAs/MCAs within the stack determining the total voltage of the stack, and the active surface area of each of the cells determines the total current. The total electrical power generated by a given fuel cell stack can be determined by multiplying the total stack voltage by total current.

Referring now to FIG. 4B, there is illustrated an embodiment of a UCA implemented in accordance with a PEM fuel cell technology. As is shown in FIG. 4B, a membrane electrode assembly (MEA) 25 of the UCA 20 includes five component layers. An ICM layer 22 is sandwiched between a pair of diffusion current collectors (DCCs). An anode 30 is situated between a first DCC 24 and the membrane 22, and a cathode 32 is situated between the membrane 22 and a second DCC 26. Alternatively, the UCA can contain two or more MEAs to form a multi-cell assembly (MCA).

In one configuration, an ICM layer 22 is fabricated to include an anode catalyst layer 30 on one surface and a cathode catalyst layer 32 on the other surface. This structure is often referred to as a catalyst-coated membrane or CCM. According to another configuration, the first and second DCCs 24, 26 are fabricated to include an anode and cathode catalyst layer 30, 32, respectively. In yet another configuration, an anode catalyst coating 30 can be disposed partially on the first DCC 24 and partially on one surface of the ICM layer 22, and a cathode catalyst coating 32 can be disposed partially on the second DCC 26 and partially on the other surface of the ICM layer 22.

The DCCs 24, 26 are typically fabricated from a carbon fiber paper or non-woven material or woven cloth. Depending on the product construction, the DCCs 24, 26 can have carbon particle coatings on one or both sides. The DCCs 24, 26, as discussed above, can be fabricated to include or exclude a catalyst coating.

In the particular embodiment shown in FIG. 4B, MEA 25 is shown sandwiched between a first edge seal system 34 and a second edge seal system 36. Adjacent the first and second edge seal systems 34 and 36 are flow field plates 40 and 42, respectively. Each of the flow field plates 40, 42 includes a field of gas flow channels 43 and ports 45 through which hydrogen and oxygen feed fuels pass. In the configuration depicted in FIG. 4B, flow field plates 40, 42 are configured as monopolar flow field plates, in which a single MEA 25 is sandwiched there between.

The edge seal systems 34, 36 provide the necessary sealing within the UCA package to isolate the various fluid (gas/liquid) transport and reaction regions from contaminating one another and from inappropriately exiting the UCA 20, and may further provide for electrical isolation and hard stop compression control between the flow field plates 40, 42.

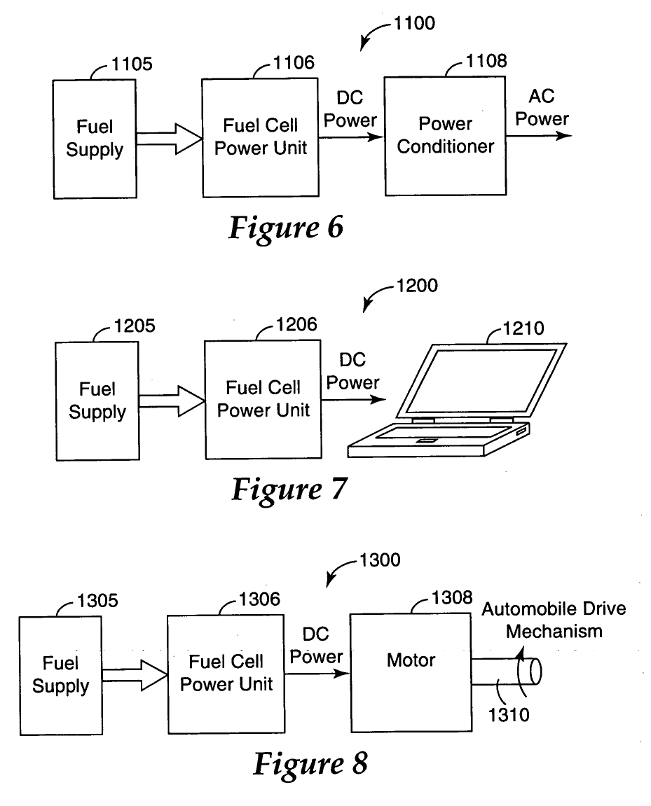

FIGS. 5-8 illustrate various systems for power generation that may incorporate fuel cell assemblies having catalyst layers formed as described herein. The fuel cell system 1000 shown in FIG. 5 depicts one of many possible systems in which a fuel cell assembly as illustrated by the embodiments herein may be utilized.

The fuel cell system 1000 includes a fuel processor 1004, a power generation section 1006, and a power conditioner 1008. The fuel processor 1004, which includes a fuel reformer, receives a source fuel, such as natural gas, and processes the source fuel to produce a hydrogen rich fuel. The hydrogen rich fuel is supplied to the power generation section 1006. Within the power generation section 1006, the hydrogen rich fuel is introduced into the stack of UCAs of the fuel cell stack(s) contained in the power generation section 1006. A supply of air is also provided to the power generation section 1006, which provides a source of oxygen for the stack(s) of fuel cells.

The fuel cell stack(s) of the power generation section 1006 produce DC power, useable heat, and clean water. In a regenerative system, some or all of the byproduct heat can be used to produce steam which, in turn, can be used by the fuel processor 1004 to perform its various processing functions. The DC power produced by the power generation section 1006 is transmitted to the power conditioner 1008, which converts DC power to AC power or DC power to DC power at a different voltage for subsequent use. It is understood that AC power conversion need not be included in a system that provides DC output power.

FIG. 6 illustrates a fuel cell power supply 1100 including a fuel supply unit 1105, a fuel cell power generation section 1106, and a power conditioner 1108. The fuel supply unit 1105 includes a reservoir that contains hydrogen fuel which is supplied to the fuel cell power generation section 1106. Within the power generation section 1106, the hydrogen fuel is introduced along with air or oxygen into the fuel cell stack(s) contained in the power generation section 1106.

The power generation section 1106 of the fuel cell power supply system 1100 produces DC power, useable heat, and clean water. The DC power produced by the power generation section 1106 may be transmitted to the power conditioner 1108, for DC to AC conversion or DC to DC conversion, if desired. The fuel cell power supply system 1100 illustrated in FIG. 6 may be implemented as a stationary or portable AC or DC power generator, for example.

In the implementation 1200 illustrated in FIG. 7, a fuel cell system uses power generated by a fuel cell power supply to provide power to operate a computer. As described in connection with FIG. 7, fuel cell power supply system includes a fuel supply unit 1205 and a fuel cell power generation section 1206. The fuel supply unit 1205 provides hydrogen fuel to the fuel cell power generation section 1206. The fuel cell stack(s) of the power generation section 1206 produce power that is used to operate a computer 1210, such as a desk top or laptop computer.

In another implementation 1300, illustrated in FIG. 8, power from a fuel cell power supply is used to operate an automobile drive mechanism 1310. In this configuration, a fuel supply unit 1305 supplies hydrogen fuel to a fuel cell power generation section 1306. The fuel cell stack(s) of the power generation section 1306 produce power used to operate a motor 1308 coupled to a drive mechanism of the automobile 1310.

### Examples:

In the following examples, a starting substrate of a single layer of nanostructured support whiskers on a microtextured catalyst transfer substrate (MCTS) (described in previously incorporated patent U.S. Pat. No. 6,136,412) was used. The layer of nanostructured elements was formed by vapor coating the MCTS substrate with 2200 Angstroms of PR149 and annealing it as described in the above references, to convert the film to the nanostructured form. The actual lots and samples used were cut from larger roll-good stock prepared as a continuous web. The starting substrates used in the examples below were from two lots, identified as Example1-1 and Example1-2.

### Example 1:

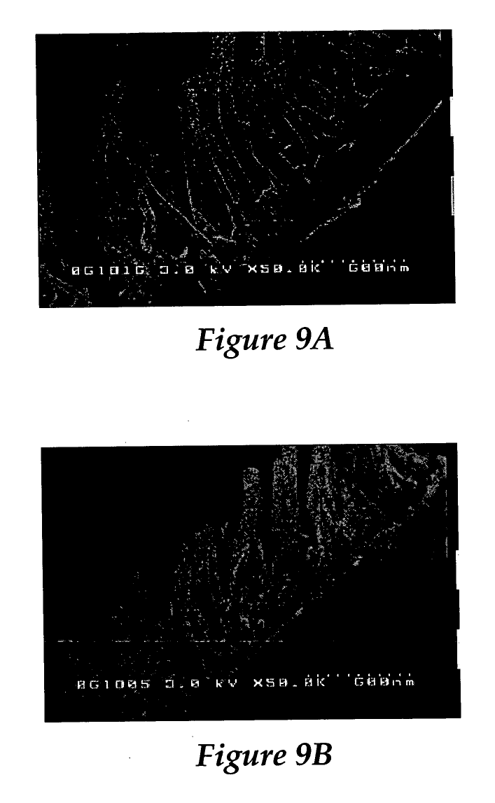

The first example illustrates the increase in whisker length obtained by coating 500 Angstroms of perylene red onto an already existing nanostructured perylene layer, then annealing it the second time. An approximately 28 cm×28 cm square sheet of nanostructured elements of PR 149 from Example1-1 was coated with the planar equivalent of approximately 500 Angstroms of PR149. The sample sheet was then annealed in vacuum a second time at 260-266 C for approximately ½ hour, not including warm-up and cool-down times. Following annealing, 1000 Angstroms of Pt was e-beam evaporated onto the nanostructured side of the sheet, and the sample identified as Example 1-3. FIG. 9A shows an SEM image at 50,000 magnification of the cross-sectional edge of the resulting Example 1-3. FIG. 9B shows, in comparison, an SEM at the same magnification, of the initial layer of whiskers on the starting substrate, Example 1-1. It can be seen that the Pt coated whiskers of Example 1-3 are considerably longer than those of Example 1-1. A measurement of the average length of the longest whiskers in Example 1-3 gives L=1.4 microns, while those in Example 1-1 are only L=0.6 microns long.

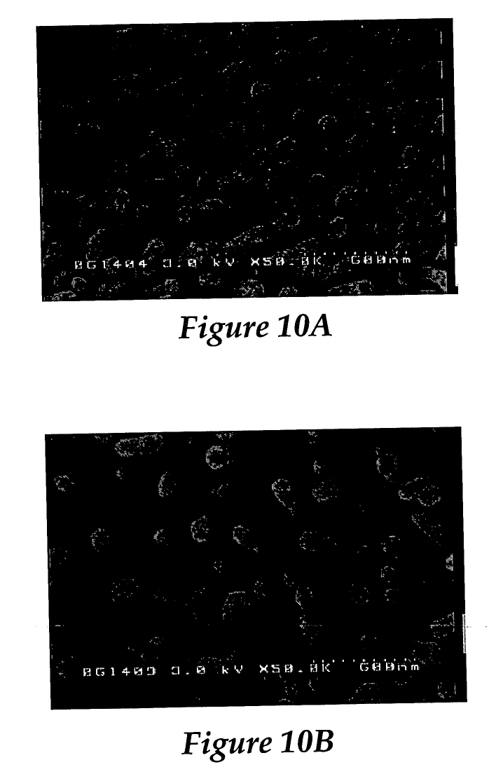

FIGS. 10A and 10B show SEM plan views at 50,000 magnification of Example 1-3 and the substrate from Example 1-1, respectively, from which the number of nanostructured elements per unit area can be determined. There appear to be about N=35 nanostructured elements per square micrometer in Example 1-1 and N=28 per square micrometer in Example 1-3. Additional SEM views at 150,000 magnification allow measurement of the widths of the nanostructured elements, W. For Example 1-3 and Example 1-1, W is 0.089 and 0.09 microns, respectively. A simple metric for estimating the geometric surface area/unit planar area, of the whiskers is A=π×W×L×N, where A has the units of cm^{2/}cm². For the above values of W, N and L, A=11.0 cm2/cm2 for Example 1-3, and A=5.9 cm^{2/}cm² for Example 1-1. These values are contained in Table 1 for comparison with other samples/lots, and show the increase in geometric surface area obtained by this invention.

Table1 includes the Pt crystallite sizes measured in the (111) orientation, by X-ray diffraction. It is reasonable to expect that for the same amount of Pt coated onto the nanostructured elements, the more area over which the Pt is distributed, the smaller the Pt grain size will be. This is illustrated by the examples provided in Table 1. For the control, Example 1-1, having the smaller geometric whisker area of 5.9 cm^{2/}cm², the grain size is largest at 108 Angstroms. For Example 1-3, with and area of 11 cm^{2/}cm^{b 2}, the grain size is reduced to 99 Angstroms.

TABLE 1

| | | | | | Geo- | |
|---|---|---|---|---|---|---|
| | | | | | metric | Pt(111) |
| | | | | | Area, A = | Grain |
| Sample | | Whisker | | | π × W × | Size |
| Identi- | | Width, | Length, | Density, | L × N | (Ang- |
| fier | Comment | W(μ) | L(μ) | N(μ⁻²) | (cm²/cm²) | stroms) |
| Example | Control, | 0.09 | 0.60 | 35 | 5.9 | 108 |
| 1-1 | no addi- | | | | | |
| | tional | | | | | |
| | PR149 | | | | | |
| Example | 500 A | 0.089 | 1.4 | 28 | 11.0 | 99 |
| 1-3 | PR149 | | | | | |
| | annealed | | | | | |
| Example | 500 A | 0.11 | 0.67 | 32 | 7.4 | 120 |
| 2-1 | PR149 | | | | | |
| | not | | | | | |
| | annealed | | | | | |
| Example | 500 A | 0.11 | 1.0 | 35 | 12.1 | 108 |
| 2-2 | PR149 | | | | | |
| | annealed | | | | | |

### Example 2:

This example provides a comparison of the lengths of nanostructured elements on layers that were annealed after deposition of a second coating of perylene red over the nanostructured elements versus a non-annealed layer. Two samples were prepared with a second coating of perylene red deposited over a nanostructured film. One sample was annealed and the other sample was not annealed. The annealed sample exhibited longer nanostructured elements as described in more detail below.

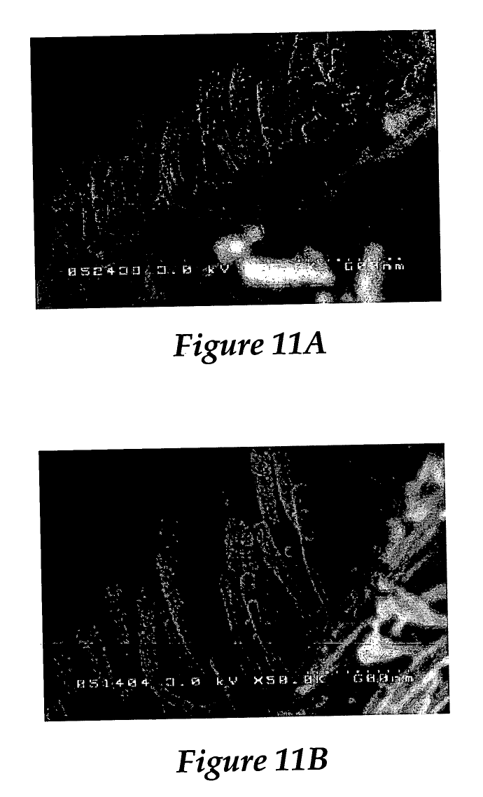

An additional amount of 500 Angstroms of PR149 was vacuum coated onto two 28cm×28 cm sheets of an existing nanostructured film from Example 1-2. The first sheet was e-beam vacuum coated with 1000 Angstroms of Pt and designated as Example 2-1. The second sheet was annealed in a vacuum at 260-264 C for approximately ½ hr, not including warm-up or cool-down times, to longitudinally extend the nanostructured elements. The second sheet was then also e-beam coated with 1000 Angstroms of Pt and designated as sample Example 2-2. FIGS. 11A and 11B are SEM cross-sectional images of sample Example 2-1 and Example 2-2, respectively resulting samples showing that the length of the nanostructured elements of Example 2-2 are approximately L=1.0 microns whereas the nanostructured elements of Example 2-1 are approximately 0.67 microns. Plan view SEM images from these samples indicate N=35/m² for Example 2-2 and N=32/m² for Example 2-1. The widths, W were approximately 0.11 m for both. These numbers give A=12.1 cm^{2/}cm² for Example 2-2 and A =7.4 cm²/cm² for Example 2-1, showing an increase in geometric surface area is produced by annealing the additional PR149 coating.

In this example, the Pt(111) catalyst crystallite sizes vary with the area of nanostructured elements. As indicated in Table 1, Example 2-2, with the larger area, has the smaller catalyst crystallite size of 108 Angstroms, while sample Example 2-1, with a smaller area, has a larger catalyst crystallite size of 120 Angstroms. The larger catalyst crystallite size of Example 2-1 compared to Example 1-1 is probably related to the different starting substrate lots used for Example 1-2 versus Example 1-1, respectively.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What we claim is:

1. A method involving formation of nanostructured support elements, comprising:
depositing a first layer of material on a substrate;
annealing the first layer to form a layer of the nanostructured support elements;
depositing a second layer of the material on the nanostructured support elements; and
annealing the second layer to longitudinally extend the nanostructured support elements.

2. The method of claim 1, wherein the material comprises an organic-based material.

3. The method of claim 2, wherein the organic-based pigment comprises delocalized π-electrons.

4. The method of claim 1, wherein the material comprises perylene red.

5. The method of claim 1, wherein:
annealing the first layer comprises annealing at a temperature of about 160° C. to about 270° C. for about 2 minutes to about 6 hours; and
annealing the second layer comprises annealing at a temperature of about 160° C. to about 270° C. for about 2 minutes to about 6 hours.

6. The method of claim 1, wherein annealing is carried out in a vacuum.

7. The method of claim 1, wherein tips of the nanostructured support elements comprise screw dislocations and annealing the second layer comprises annealing the second layer to continue growth of the nanostructured support elements at the screw dislocations.

8. The method of claim 1, wherein the extended nanostructured support elements have an aspect ratio of length to mean cross sectional dimension diameter in a range of about 3:1 to about 200:1.

9. The method of claim 1, wherein the extended nanostructured support elements have a length greater than about 1.5 μm.

10. The method of claim 1, wherein an areal density of the extended nanostructured support elements ranges from about 10⁷ to about 10¹¹ nanostructured support elements per cm².

11. The method of claim 1, further comprising depositing a catalyst material on the extended nanostructured support elements.

12. The method of claim 11, wherein depositing the catalyst material comprises depositing an inorganic material.

13. The method of claim 11, wherein depositing the catalyst material comprises depositing a metal.

14. The method of claim 11, wherein depositing the catalyst material comprises depositing a platinum group metal.

15. The method of claim 1, further comprising forming a thin film of nanoscopic catalyst particles supported by the extended nanostructured support elements.

16. The method of claim 1, wherein depositing the first layer on the substrate comprises depositing the first layer on a microtextured substrate.

17. The method of claim 1, further comprising:
coating the extended nanostructured support elements with a catalyst material; and
transferring the layer of catalyst coated extended nanostructured support elements to at least one surface of an ion conductive membrane to form a catalyst coated membrane.

18. The method of claim 1 wherein the substrate is diffusion current collector.

19. The method of claim 1, further comprising forming a membrane electrode assembly using the layer of extended nanostructured support elements.

20. The method of claim 19, further comprising incorporating the membrane electrode assembly into an electrochemical device.

21. A method for forming nanostructured support elements, comprising:
depositing a layer of perylene red on a substrate;
annealing the layer to form nanostructured support elements;
coating the nanostructured support elements with perylene red; and
annealing the coated nanostructured support elements to longitudinally extend the nanostructured support elements.

22. The method of claim 21, further comprising depositing a catalyst on the extended nanostructured support elements.

23. The method of claim 21, wherein depositing the layer of perylene red on the substrate comprises depositing the layer of perylene red on a microtextured substrate.

24. The method of claim 21, further comprising:
coating the extended nanostructured support elements with a catalyst; and
transferring the catalyst coated extended nanostructured support elements to at least one surface of an ion conductive membrane to form a catalyst coated membrane.
